(19) United States
(12) Patent Application Publication
(10) Pub. No.: US 2025/0171191 A1
(43) Pub. Date: May 29, 2025

(54) A COMPOSTABLE CONTAINER FOR PACKAGING OF LIQUID, FATTY- AND/OR FROZEN FOOD

(71) Applicant: Stora Enso OYJ, Helsinki (FI)

(72) Inventors: Chris Bonnerup, Floda (SE); Kaj Backfolk, Lappeenranta (FI); Magnus Ekberg, Fors (SE)

(73) Assignee: Stora Enso OYJ, Helsinki (FI)

(21) Appl. No.: 18/839,892

(22) PCT Filed: Feb. 17, 2023
(86) PCT No.: PCT/IB2023/051457

§ 371 Date: Aug. 20, 2024

(30) Foreign Application Priority Data
Feb. 21, 2022 (SE) 2230048-7

(51) Int. Cl. B65D 3/22; B32B 5/16; B32B 29/00; B65D 3/06; B65D 3/14; B65D 65/46; D21J 1/08

(52) U.S. Cl. CPC B65D 3/22; B32B 5/16; B32B 29/007; B65D 3/06; B65D 3/14; B65D 65/466; D21J 1/08; B32B 2255/12; B32B 2255/26; B32B 2255/28; B32B 2307/546; B32B 2307/7163; B32B 2307/718; B32B 2307/72; B32B 2439/70

(57) ABSTRACT

The invention relates to a compostable container formed from at least one first paperboard substrate having a first side, facing the inside of the container and a second side facing the outside of the container. The first paperboard substrate comprises a first paperboard core layer, and a barrier coating layer applied on the first side, which barrier coating layer comprises a natural polymer, a natural ester or a rosin, or combinations thereof, in an amount of 70-100 wt % as calculated on the total dry weight of said barrier coating layer. The said container is formed at least by a first region of the first side overlapping with a second region of the second side, wherein the paperboard substrate further comprises an adhesive applied on at least one of the first and second region, which adhesive layer is applied on 0.1-10% of the total area of the first and second side of said paperboard substrate. The container of the invention comprises low, or no amounts of plastics manufactured from bio-based, fossil or synthetic starting substances. The container is particularly suitable for the packaging of liquid, frozen and fatty food.

### FIELD OF THE INVENTION

The present invention relates to a compostable container.

### BACKGROUND

Fiber based material used in containers, such as cups, for liquids, fatty-or frozen food is usually provided with barrier coatings both on the inside (facing the packed item) and on the outside (print-side). The barrier coating applied on the inside makes the material resistant against e.g. liquids, grease and/or aroma and enables it to withstand the influence of the packed item on the packing material. The barrier on the outside is applied to protect the packed item from the surrounding, especially from water vapor and condensation that is formed on the surface due to temperature fluctuations or temperature differences between container outside vs container inside. In addition to provide barrier properties, coatings on the inside are normally also heat-sealable to enable sealing of the fiber-based material to form the container.

The most commonly used coating materials for creating barrier- and heat-sealable properties on fiber-based packaging materials include polyolefins, such as polyethylene (PE) or polypropylene (PP). Paperboard intended for cups is oftentimes provided with a polyolefin coating to provide barrier and heat sealability both on the inside and on the outside.

Environmental concerns and recent legislation, such as the EU's Directive on single-use plastics (SUPD), have created a demand for disposable fiber-based containers, such as cups, that contain no or very low amounts plastics manufactured from bio-based, fossil or synthetic starting substances. Barrier coatings based on natural polymers have been tested in the art, but many of these have not been considered to provide high enough barrier properties. In addition, such coatings oftentimes provide no or poor heat-sealablility, at least not when applied at low coat-weights. A high content of natural polymers in barrier layers is further oftentimes associated with problems in repulping or broke handling.

There thus remains a need for a compostable container for liquid, fatty- and/or frozen food that provides enough barrier properties but contain no or low amounts of plastics.

### DESCRIPTION OF THE INVENTION

It is an object of the present disclosure to provide an alternative to the plastic coatings commonly used as barrier coatings for providing barrier properties on containers for liquid, fatty- and/or frozen food.

It is a further object of the present disclosure to provide a leak resistant container for liquid, fatty- and/or frozen food that contain low or no amounts of plastics manufactured from bio-based, fossil or synthetic starting substances.

It is a further object of the present disclosure to provide a container that is compostable and has barrier properties against at least one of liquids, grease and aroma.

It is a further object of the present invention to provide a container, such as a cup, for liquid, fatty- and/or frozen food that provides barrier properties against one of liquids, grease and aroma and that is recyclable.

The above-mentioned objects, as well as other objects as will be realized by the skilled person in the light of the present disclosure, are achieved by the various aspects of the present disclosure.

According to a first aspect illustrated herein, there is provided a compostable container formed from at least one first paperboard substrate having a first side facing the inside of the container and a second side facing the outside of the container,
wherein the first paperboard substrate comprises a first paperboard core layer, and a barrier coating layer applied on the first side, which barrier coating layer comprises a natural polymer, a natural ester or a rosin, or combinations thereof, in an amount of 70-100 wt % as calculated on the total dry weight of said barrier coating layer, which container is formed at least by a first region of the first side overlapping with a second region of the second side, wherein the first paperboard substrate further comprises an adhesive applied on at least one of the first and second region,
wherein said adhesive layer is applied on 0.1-10% of the total area of the first and second side of said first paperboard substrate,
and wherein the first region and the second region are sealed to one another.

The container of the invention comprises low or no amounts of plastics manufactured from bio-based, fossil or synthetic starting substances and therefore fall outside the definition of single-use plastics according to SUPD, 2019. In embodiments, the container comprises less than 5 wt % of plastics manufactured from bio-based, fossil or synthetic starting substances as calculated on the total dry weight of the container. The container comprises a sealable adhesive layer which preferably is spot coated to only cover regions of the paperboard substrate that overlaps and are sealed to other regions. In this way, the barrier coating does not need to be heat sealable, or may have low sealing performance, and may comprise a high amount of natural polymers, natural esters and/or rosins. Preferably, the adhesive layer is applied on the first and the second region. The adhesive layer is preferably applied on 0.1-5% or 0.1-3% of the total area of the first and second side of said paperboard substrate. The container of the invention is particularly suitable for the packaging of food but may in some embodiment also be suitable for packaging or storing other type of contents, such as plants or mechanical spare parts.

The term “natural polymer” as used herein is meant to define polymers which are a result of a polymerization process that has taken place in nature. Polymerization processes that take place in nature are those relying on the metabolism and biosynthesis of organisms and microorganisms such as animals, plants and algae, fungi and/or bacteria. The biosynthesis may take place in the nature or may be induced in an artificial cultivation and fermentation process.

In a preferred embodiment, the natural polymer is further a chemically unmodified natural polymer.

A “chemical unmodified natural polymers” as used herein is meant to define natural polymers that have not been chemically modified. Chemical unmodified natural polymers may further be defined as in point 40 of Article 3 of Regulation (EC) No 1907/2006 of the European Parliament and of the Council of 18 Dec. 2006 concerning the Registration, Evaluation, Authorisation and Restriction of Chemicals (REACH). The chemically unmodified natural polymer may be thermally and/or mechanically treated or processed e.g. by fractionation, extraction, distillation, drying, washing, purification and/or emulsification.

A “natural ester” as used herein is meant to define an ester that is extracted from renewable natural sources, such as from animals or plants, e.g. from corps like soyabean, sunflower, rapeseed (canola), flax or poppy. The natural ester may be selected from the group consisting of triglycerides, phospholipids and cholesteryl esters, or combinations thereof. Preferably, the natural ester is chemically unmodified.

A “rosin” as used herein is meant to define rosin that is extracted from plants, primarily from wood, particularly softwood and preferably pine. Preferably, the rosin is chemically unmodified.

The barrier coating layer provides the container with a barrier against at least one of liquids, grease and aroma. In embodiments, the paperboard substrate, comprising the paperboard core layer and the barrier coating layer, exhibits a water absorption value, as measured using COBB 600 in accordance with SCAN-P 12:64, of below 25 g/m², preferably of below 20 or 10 g/m₂ and/or a KIT value, as measured in accordance with TAPPI T559, of above 8 preferably of above 10 or above 12.

The container may further exhibit a gas barrier at 23° C./0% RH of less than 50 cc/m²/24 h, preferably less than 30 cc/m²/24 h and most preferably less than 10 cc/m²/24 h. The container is further preferably substantially pinhole free and may exhibit less than 5 pinholes/m², preferably less than 2 pinholes/m².

The barrier coating layer may further provide a barrier against mineral oil hydrocarbons (MOAH, MOSH) and/or against non-intentionally added substances (NIAS). Such barrier properties are important especially in case recycled fibers are used in the paperboard core layer.

In embodiments, the said first paperboard substrate has a first edge and an opposite second edge, wherein said first region defines an area on the first side in proximity with the first edge and the second region defines an area on the second side in proximity with the second edge.

In embodiments, the said first and second region are sealed to one another so that said first paperboard substrate forms a sleeve having an upper peripheral edge and an opposite lower peripheral edge, and a third region defining an area on the first side in proximity with the lower peripheral edge. In these embodiments, the container further comprises a bottom formed from a second paperboard substrate comprising a second paperboard core layer, wherein said second paperboard substrate has a substantially cylindrical shape and a first bottom side primarily facing the inside of the container and a second bottom side facing the outside of the container and a downwardly bent peripheral edge portion having a first bottom edge region defining an area of the surface of the peripheral edge portion formed as an extension of the first bottom side and a second bottom edge region defining an area of the peripheral edge portion formed as an extension of the second bottom side. Said bottom is attached to the sleeve so that the third edge region overlaps at least with the first bottom edge region and the adhesive layer is applied on the third region of the first paperboard substrate so that the third edge region and the first bottom region is sealed to one another.

The third edge region may further overlap with the second bottom edge region, so that the third edge region and the second bottom edge region is sealed to one another. This is accomplished by the lower end of the sleeve being bent downwardly so as to cover the peripheral edge portion.

The second paperboard substrate may further comprise a barrier coating layer applied on the second paperboard core layer on the first bottom side (facing the inside of the container), which barrier coating layer comprises a natural polymer, a natural ester, or a rosin in an amount of 70-100 wt % as calculated on the total dry weight of said barrier coating layer.

The natural polymer of the barrier coating on the second paperboard substrate may be selected from the same group of natural polymers as the barrier coating on the first paperboard substrate. The natural polymer, the natural ester or the rosin of the barrier coating applied applied on the second paperboard substrate may further also be chemically unmodified.

In embodiments, the second paperboard substrate may further comprise an adhesive layer applied at least on the first bottom region, wherein said adhesive layer is applied on 0.1-10%, preferably on 0.1-5%, or on 0.1-3%, of the total area of the first and second bottom area.

The container of the invention, with a barrier coating comprising a high amount of a natural polymer, natural ester and/or a rosin, and an adhesive layer preferably only applied on the sealing areas, is compostable. In embodiments, the container is compostable according to the standard for compostability EN 13432. In embodiments, the container is home compostable, preferably according to the Australian standard AS 5810. The container may further be recyclable. The container may be recyclable such that the reject received from repulping of the container, as determined according to PTS test method RH021/97, is less than 20 wt %, preferably less than 15 wt %, most preferably less than 10 wt %, based on a dry weight of the container of 100 wt %. Preferably, the container is biodegradable such that it does not create microplastics at the composting thereof. Microplastics as used herein refers to non-biodegradable plastic particles with a length of less than 5 mm.

The barrier coating forming the barrier coating layer may be applied onto the paperboard core layer by any conventional application method, including both liquid film coating and extrusion coating. The barrier coating layer is preferably formed by means of a liquid film coating process; i.e. in the form of an aqueous solution or dispersion which, on application, is spread out to a thin, uniform layer on a substrate and thereafter dried. The barrier coating can be applied by contact or non-contact coating methods. Examples of useful coating methods include, but are not limited to rod coating, curtain coating, film press coating, cast coating, transfer coating, size press coating, flexographic coating, gate roll coating, twin roll HSM coating, blade coating, such as short dwell time blade coating, jet applicator coating, spray coating, gravure coating or reverse gravure coating.

The barrier coating layer is preferably free from plastics manufactured from bio-based, fossil or synthetic starting substances. The barrier coating layer may comprise at least 90 wt %, or at least 95 wt % or at least 99 wt % or even 100 wt % biodegradable components, as calculated on the total weight of said barrier coating layer.

In embodiments, the barrier coating layer, applied on the first side and on the optional first bottom side, comprises a natural polymer in an amount 80-100 wt %, or 90-100 wt %, or 95-100wt % as calculated on the dry weight of the barrier coating layer. Preferably, the natural polymer has at least 90%, preferably 95% or 99% purity. In embodiments, the barrier coating layer comprises a natural polymer, but is substantially free from esters and rosins. Preferably, the natural polymer is mechanically and/or thermally processed to reduce microbe content and to enhance the dispersion of the natural polymer in the coating composition.

The natural polymer is preferably selected from the group consisting of a polysaccharide, proteins, natural rubber, lignin, tall oil and polyhydroxyalkanoates (PHA) or combinations thereof. The polysaccharide may e.g. be starch, xyloglucan, cellulose, hemicellulose, or alginate or combinations thereof. The cellulose may e.g. be microfibrillated cellulose or highly refined cellulose fibers. In preferred embodiments, the natural polymer is a polysaccharide or a protein. In embodiments, the natural polymer is a cold-water soluble polymer. As use herein, “cold-water soluble polymer” is meant to define a polymer that is soluble in water at a temperature of 23° C. or less. Such cold-water soluble polymers are easier to recycle and have a higher compostability as compared to polymers that are not soluble in cold water. The cold-water soluble polymer is preferably selected from the group consisting of cellulose, hemicellulose, starch, pectin, protein, ketin, pectin, guar gum, mannan, dextran, xanthan gum, agar, chitosan, soy protein, zein, and/or combinations thereof. The cold-water soluble polymer may have been pre-cooked to provide the water-soluble properties.

The barrier coating layer is preferably applied on the first side and on the optional first bottom side at a dry coat weight in an amount in the range of 0.1-20 gsm, preferably 0.5-10 gsm, or 2-10 gsm. Some of the above-mentioned natural polymers may be heat-sealable to some extent, such as e.g. PHA, but not at the low coat weight that the barrier coating layers preferably are applied at.

In embodiments, the barrier coating layer is applied directly onto and adjacent to the first and optional second paperboard core layer and form the outermost coating layer on the inside of the container and is adapted to be in contact with the content of the container. Thus, preferably the barrier coating layer forms the only barrier coating layer on the inside of the container.

In embodiments, the barrier coating layer applied on the first side and on the optional first bottom side comprises pigments, preferably in an amount in the range of 1-30 wt %, or in the range of 1-15 wt %, as calculated on the total dry solid weight of said barrier coating layer. The pigments may be selected from the group of clay, precipitated calcium carbonate (PCC), titanium dioxide, silica, silicate, nanopigments, plastic pigments, talcum and/or combinations thereof.

The barrier coating layer may comprise additives, preferably in an amount in a range of 1-10 wt %, preferably of 1-5 wt %, as calculated on the total dry weight of said barrier coating layer. The barrier coating forming the barrier coating layer has preferably a pH of around 3-10, more preferably of 3-8.

In embodiments, the barrier coating layer comprises an organic acid, preferably citric acid or tartaric acid. These organic acids have dual effects as crosslinkers and as biocides. Preferably, the organic acid is present in the barrier coating layer in an amount in the range of 0.01-5 wt % wt %, preferably in an amount in the range of 0.1-4 wt %, or 0.5-3 wt %, as calculated on the total dry weight of said barrier coating layer, or 0. 1-1 wt %. In these amounts, the said organic acid counteracts microbiological growth in the recycling process, but still does not substantially affect the compostability of the container negatively. In these embodiments, a base, such as NaOH or KOH may be added to the coating to adjust the pH.

In embodiments, the barrier coating layer applied on the first side and on the optimal first bottom side comprises a humectant, preferably in an amount in the range of 0.5-5 wt % as calculated on the total dry weight of said barrier coating layer. As used herein, the term “humectant” refers to a hygroscopic substance added to a material to keep it moist. The humectant is preferably selected from the group of sugar alcohols, propylene glycol, hexylene glycol, butylene glycol, polyethylene glycol (PEG) and urea or a combination thereof. The addition of a humectant enhances the flexibility of the natural polymers and improves the recyclability of the container.

To minimize the risk of pinholes in the barrier coating layer, the barrier coating layer may preferably be applied in at least two different coating steps, optionally with drying in-between the steps. The barrier coating layer can thus comprise at least a first and a second sub-layer, each of said first and second sub-layer comprising the natural polymer, the natural ester and/or the rosin in an amount of 70-100 wt % as calculated on the total dry weight of said sub-layer.

In embodiments, the first layer forms the innermost sub-layer and comprises a natural polymer in an amount of 70-100 wt % as calculated on the total dry weight of said first sub-layer and the second sub-layer forms an outermost sub-layer and comprises a natural ester or a rosin in an amount of 70-100 wt % as calculated on the total dry weight of said second sub-layer. In these embodiments, the first sub-layer may be applied at a coat-weight of 1-10 gsm, or 1-6 gsm, while the second sub-layer may be applied at a dry coat weight of 0.1-10 gsm, or 0.5-8 gsm or 0.5-5 gsm. In a preferred embodiment, the first, innermost, sub-layer comprises microfibrillated cellulose or highly refined cellulose fibers in an amount of 70-100 wt % and the second, outermost, sub-layer comprises a natural ester or a rosin in an amount of 70-100 wt %, all percentages calculated on the total dry weight of the said sub-layer.

The compostable container may further comprise a barrier coating on the outside/print-side to form a barrier primarily against moisture arising from condensation. In embodiments, the first paperboard substrate comprises a second barrier coating layer on the second side, which second barrier coating layer comprises a natural polymer, a natural ester and/or a rosin in an amount of 70-100 wt % as calculated on the total dry weight of said second barrier coating layer. In preferred embodiments, the second barrier coating layer comprises a natural polymer in an amount of 70-100 wt % as calculated on the total dry weight of said second barrier coating layer. The natural polymer, the natural ester and/or the rosin is preferably chemically unmodified and may be selected from the same group of natural polymers, the natural esters and/or the rosins as those of the barrier coating layer applied on the first side. The second barrier coating may further comprise additives and pigments selected from the same lists of additives and pigments as those of the barrier coating applied on the first side.

In preferred embodiments, the second barrier coating on the second side is applied directly onto and adjacent to the paperboard core layer to form the outermost coating layer on the outside of the container. Thus, the second barrier coating is preferably the only barrier coating on the outside. The second barrier coating may be applied on the second side at a dry coat weight of 1-20 gsm, preferably 0.5-10 gsm, or 2-10 gsm.

Examples of preferred barrier coating structures include:

| | |
|---|---|
| Print side of the container | Inside of the container |

```
  natural polymer/paperboard core layer/natural polymer/natural ester
  natural ester/paperboard core layer/natural polymer/natural ester
  rosin/paperboard core layer/natural polymer/rosin
  natural polymer/paperboard core layer/natural polymer/rosin
  natural ester/paperboard core layer/natural polymer/rosin
```

In the above disclosed preferred barrier coating structures; “natural polymer”, “natural ester” and “rosin” refer to a barrier coating layer comprising the said component in an amount of 70-100 wt %. In these structures, the natural polymer is preferably microfibrillated cellulose or highly refined cellulose fibers, most preferably chemically unmodified.

The adhesive layer is preferably applied at least on the first region in a dry coat weight of 1-50gsm, preferably 1-20 or 1-10 gsm. The adhesive layer may be selected from the group consisting of hot melt adhesives, including thermoplastics applied in molten form such as ethylene-vinyl-acetate based adhesives; contact adhesives, including e.g. natural rubber and polychloroprene; pressure-sensitive adhesives such as acrylate-based polymers; dry-curing adhesives including solvent-based adhesives and polymer dispersion adhesives such as polyvinyl acetate (PVA); multi-component adhesives; ultraviolet light curing adhesives, including e.g. acrylic-based UV curing adhesives; heat curing adhesives, including e.g. thermoset epoxies, urethanes and polyimide; and moisture curing adhesives, including e.g. cyanoacrylates and urethanes.

A “paperboard core layer” as used herein refers a web of a fiber-based substrate comprising cellulose fibers, preferably to at least 50 wt %, or at least 70 wt %. The substrate may further comprise fillers and chemical additives. A typical fiber-based substrate used for packaging material comprises at least one ply, preferably several plies. The paperboard core layer may comprise bleached and/or unbleached fibers of hardwood and/or softwood and it may be surface sized. The paperboard core layer may comprise recycled fibers and/or broke. The paperboard core layer is preferably a multilayer packaging paperboard, comprising at least two plies, a back ply and a top ply. The paperboard core layer may have a basis weight of at least 100 gsm, or at least 120 gsm, preferably at least 150 gsm, such as between 100-500 gsm, or 120-500 gsm, or 150-400 gsm. Such a multilayer paperboard substrate is particularly suitable for liquid and/or food packaging.

In embodiments, the paperboard core layer comprises a top ply, a back ply and at least one middle ply. Preferably, said middle ply has a density of below 750 kg/m³, or below 700 kg/m³, preferably below 650 kg/m³ or below 600 kg/m³, such as 300-750 kg/m³, or 300-650 kg/m³ kg/m³. The middle ply may provide bulk to the paperboard substrate. The paperboard core layer used in the invention is preferably substantially free from synthetical polymers for providing bulk. In preferred embodiments, the middle ply may be foam formed to provide bulk. A foam formed substrate endures heat treatment better than synthetical polymers. In addition, such a core layer is composted more easily. The paperboard core layer may further comprise de-bonders, i.e. surface active components that hinder fiber/fiber bonds by acting as spacers between fibers making it easier to compost the paperboard. In foam-forming, a large amount of air is added to an aqueous pulp suspension in the presence of a surfactant or a surface active polymer. The air bubbles formed prevent fiber flocculation, enhance dewatering and enables production of light weight, bulky structures. The term foam as used herein, refers to a substance made by trapping air or gas bubbles inside a solid or liquid.

The paperboard core layer may also be optimized to improve the compostability and recyclability. In embodiments, the first and optional second paperboard core layer is made of 90-100 wt %, preferably 95-100 wt % or even 100 wt % bleached pulp, as calculated on the total fiber weight of said core layer. The first and optional second paperboard core layer may comprise less than 10 wt %, preferably less than 5 wt % pulp selected from the group of chemi-thermo mechanical pulp (CTMP) and thermomechanical pulp (TMP). A high amount of bleached pulp and/or a low amount of CTMP and TMP improves the recyclability and the compostability of the container.

In embodiments, the first and optional second paperboard core layer comprises less than 1 wt %, preferably less than 0.5 wt % wet strength agents, as calculated on the total fiber weight of said paperboard core layer, such as between 0-1 wt %, 0-0.5 wt % or 0.1-1 wt % or 0.1-0.5 wt %. Also, a low amount of wet strength agents has shown to enhance the compostability of the container and lower the reject rate in recycling. The term “Wet Strength Agents” as used herein refers to wet strength chemicals, typically wet strength resins, that improve the tensile properties of the paperboard in wet state by crosslinking the cellulose fibers with covalent bonds. Wet strength agents may include both permanent and temporary wet strength agents, e.g. of the urea resins, melamine resins, polyamidoamine-epichlorhydrine (PAAE) resins, PAM-glyoxal resins, glyoxal, glyoxal resins, dialdehyde-starch.

The paperboard core layer may further comprise 1-30 wt % broke as calculated on the total dry weight of said core layer, which broke originates from a paperboard with a barrier coating comprising a chemically unmodified natural polymer, ester and/or rosins as the only barrier coating layer.

The first and optional second paperboard substrate has preferably a high stiffness. In embodiments, the first and optional second paperboard substrate exhibits a bending resistance a bending resistance index, 15 degrees (determined according to IS02493-1) in machine direction (MD) of above 12 Nm6/kg³, preferably above 13 Nm6/kg³ and/or a bending resistance index, 15 degrees (determined according to IS02493-1) in cross direction (CD) of above 5 Nm6/kg³, preferably above 6 Nm6/kg³

In the formation of the first paperboard substrate, a barrier coating composition comprising a natural polymer, a natural ester, a rosin or combinations thereof is preferably applied onto the first side and optional second side so that it covers the whole surface/s, including region/s to be applied with the adhesive. The paperboard core layer, applied with the first and optional second barrier coating layer is preferably treated with ultraviolet light (UV) or electron beam (EB) treatment before spot coating of the adhesive. In this way, microbes are deactivated and the adhesion to the adhesive is improved. Similarly, also in the formation of the optional second paperboard substrate, a barrier coating composition is preferably applied onto both the first bottom side and on the first bottom edge region. The second paperboard core layer, applied with a barrier coating layer, may also be UV or EB treated before the optional spot coating of the adhesive.

### DESCRIPTION OF AN EMBODIMENT

In the following, the invention will be further illustrated by description of an example with reference to the accompanying drawings, wherein:

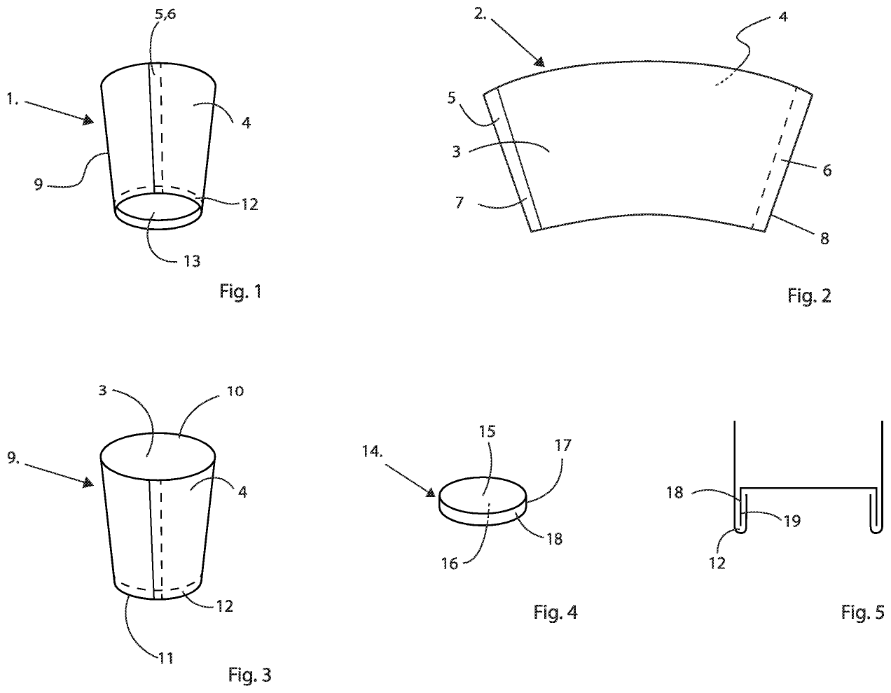

FIG. 1: shows a cup formed from a first and second substrate according to the invention

FIG. 2: shows a paperboard substrate forming the sleeve of the cup

FIG. 3: shows the sleeve of the cup.

FIG. 4: shows a bottom to be attached to the sleeve for forming the cup

FIG. 5: shows a cross-section of the cup showing how the bottom is attached to the sleeve.

A cup (1) according to the invention comprising a sleeve, having an inside (3) and an outside (4), and a bottom (13) is shown in FIG. 1.

The sleeve (9) of the cup, shown in FIG. 3, is made from a paperboard substrate (2) shown in FIG. 2. The paperboard substrate (2) is applied with a barrier coating comprising a natural polymer both on the first side forming inside (3) and on the second side forming the outside (4) of the thereof formed cup (1). The paperboard substrate (2) comprises a first edge (7) and a second opposite edge (8). An adhesive layer is further applied on a first region (5) in proximity with the first edge (7) on the first side (3), and on a second region (6) in proximity with the second edge (8) on the second side (4). In the formation of the sleeve (9), the first and the second region (5, 6) overlap and are sealed to one another. The formed sleeve comprises an upper peripheral edge (10) for forming of a rim, and a lower peripheral edge (12) to be attached to the bottom (13). The sleeve (9) is provided with an adhesive layer also on a third edge region (12) defining an area on the first side (3) in proximity with the lower peripheral edge (11) of the sleeve.

A second paperboard substrate (14) shown in FIG. 4 forms the bottom (13) of the cup (1). The bottom (13, 14) has a substantially cylindrical shape and a first bottom side (15) adapted to face the inside of the cup, and a second bottom side (16) adapted to face the outside of the cup and a downwardly bent peripheral edge portion (17). The edge portion (17) has a first bottom edge region (18) defining an area of the surface of the peripheral edge portion formed as an extension of the first bottom side (15), and a second bottom edge region (19) defining an area of the peripheral edge portion formed as an extension of the second bottom side. The bottom (13, 14) is provided with a barrier coating layer at least on the first bottom side (15), which barrier coating layer comprises a natural polymer.

In the attachment of the bottom (13, 14) to the sleeve (9), the lower end of the sleeve is bent downwardly so as to cover the peripheral edge portion (17) and is joined and sealed to both the first and to the second bottom edge region (18, 19).

While certain representative embodiments and details have been shown for purposes of illustrating the invention, it will be apparent to those skilled in the art that various changes in the invention disclosed herein may be made without departing from the scope of the invention, which is defined in the appended claims.

1. A compostable container formed from at least one first paperboard substrate having a first side facing an inside of the container and a second side facing an outside of the container,
wherein the at least one first paperboard substrate comprises a first paperboard core layer, and a barrier coating layer applied on the first side, wherein the barrier coating layer comprises a natural polymer, a natural ester, a rosin, or combinations thereof, in an amount of 70-100 wt % as calculated on a total dry weight of said barrier coating layer,
wherein the compostable container is formed at least by a first region of the first side overlapping with a second region of the second side, wherein the at least one first paperboard substrate further comprises an adhesive layer applied on at least one of the first and second regions, wherein said adhesive layer is applied on 0.1-10% of a total area of the first and second sides of said first paperboard substrate,
and wherein the first region and the second region are sealed to one another.

2. The compostable container according to claim 1, wherein the natural polymer is a chemically unmodified natural polymer.

3. The compostable container according to claim 1, wherein the adhesive layer is applied on the first and the second region.

4. The compostable container according to claim 1, wherein the at least one first paperboard substrate has a first edge and an opposite second edge and wherein said first region defines an area on the first side in proximity with the first edge and the second region defines an area on the second side in proximity with the second edge.

5. The compostable container according to claim 3, wherein said first and second region are sealed to one another so that said first paperboard substrate forms a sleeve having an upper peripheral edge and an opposite lower peripheral edge, and a third region defining an area on the first side in proximity with the lower peripheral edge,
wherein the compostable container further comprises a bottom formed from a second paperboard substrate comprising a second paperboard core layer, wherein said second paperboard substrate has a substantially cylindrical shape and a first bottom side primarily facing the inside of the container and a second bottom side facing the outside of the container and a downwardly bent peripheral edge portion having a first bottom edge region defining an area of a surface of the peripheral edge portion formed as an extension of the first bottom side and a second bottom edge region defining an area of the peripheral edge portion formed as an extension of the second bottom side,
wherein the bottom is attached to the sleeve so that the third edge region overlaps at least with the first bottom edge region, wherein the adhesive layer is applied on the third region of the first paperboard substrate, and wherein the third edge region and the first bottom region are sealed to one another.

6. The compostable container according to claim 5, wherein the third edge region further overlaps with the second bottom edge region, wherein the third edge region and the second bottom edge region are sealed to one another.

7. The compostable container according to claim 5, wherein the second paperboard substrate comprises a barrier coating layer applied on the second paperboard core layer on the first bottom side, which wherein said barrier coating layer comprises a natural polymer, a natural ester, a rosin, or combinations thereof, in an amount of 70-100 wt % as calculated on a total dry weight of said barrier coating layer.

8. A The compostable container according to claim 5, wherein the second paperboard substrate further comprises an adhesive layer applied at least on the first bottom region, wherein said adhesive layer is applied on 0.1-10% of a total area of the first and second bottom sides.

9. The compostable container according to claim 1, wherein the compostable container is compostable according to EM13432.

10. The compostable container according to claim 1, wherein the container is recyclable such that a reject received from repulping of the compostable container, as determined according to PTS test method RH021/97, is less than 20 wt %, based on a dry weight of the compostable container of 100 wt %.

11. The compostable container according to claim 1, wherein the natural polymer is selected from a group consisting of: a polysaccharide, proteins, natural rubber, lignin, tall oil, or polyhydroxyalkanoates (PHA) or combinations thereof.

12. The compostable container according to claim 1, wherein the natural polymer is cold-water soluble.

13. The compostable container according to claim 1, wherein the barrier coating layer applied on the first side has a dry coat weight in an amount in a range of 0.1-20 gsm.

14. The compostable container according to claim 1, wherein the barrier coating layer is applied directly onto and adjacent to at least one first paperboard core layer, and wherein said barrier coating layer forms an outermost coating layer on the inside of the compostable container and is configured to be in contact with a contents of the compostable container.

15. The compostable container according to claim 1, wherein the barrier coating layer applied on the first side comprises 1-30 wt % pigment.

16. The compostable container according to claim 1, wherein the barrier coating layer applied on the first side and on the optional first bottom side comprises an organic acid.

17. The compostable container according to claim 1, wherein the barrier coating layer applied on the first side comprises a humectant.

18. The compostable container according to claim 1, wherein the barrier coating layer is built up by at least a first and a second sub-layer, each of said first and second sub-layers comprise the chemically unmodified natural polymer, the natural ester, the rosin, or the combinations thereof in an amount of 70-100 wt % as calculated on a total dry weight of said sub-layer.

19. The compostable container according to claim 18, wherein the first sub-layer forms an innermost sub-layer and comprises the natural polymer in an amount of 70-100 wt % as calculated on the total dry weight of said first sub-layer, and wherein the second sub-layer forms an outermost sub-layer and comprises the natural ester or the rosin in an amount of 70-100 wt % as calculated on the total dry weight of said second sub-layer.

20. The compostable container according to claim 1, wherein the first paperboard substrate comprises a second barrier coating layer on the second side, wherein the second barrier coating layer comprises a natural polymer, a natural ester, a rosin, in an amount of 70-100 wt % as calculated on a total dry weight of the second barrier coating layer.

21. The compostable container according to claim 19, wherein the second barrier coating on the second side forms an outermost coating layer on the outside of the container.

22. The compostable container according to claim 1, wherein adhesive layer is applied at least on the first region at a dry coat weight of 1-50 gsm.

23. The compostable container according to claim 1, wherein at least one first paperboard core layer is made of 90-100 wt % bleached pulp, as calculated on a total fiber weight of said paperboard core layer.

24. The compostable container according to claim 1, wherein the first paperboard core layer comprises less than 10 wt % pulp selected from a group consisting of: CTMP and TMP, as calculated on a total fiber weight of said paper core layer.

25. The compostable container according to claim 1, wherein the first paperboard core layer comprises less than 1 wt % wet strength agents, as calculated on the total fiber weight of said core layer.

26. The compostable container according to claim 1, wherein the first paperboard core layer comprises a top ply, a back ply, and at least one middle ply, wherein said at least one middle ply is foam formed.
